(19) United States
(12) Patent Application Publication
(10) Pub. No.: US 2021/0297885 A1
(43) Pub. Date: Sep. 23, 2021

(54) Intelligent Measurement Handling

(71) Applicant: Apple Inc., Cupertino, CA (US)

(72) Inventors: Tarakkumar G. DHANANI, San Jose, CA (US); Alosious Pradeep PRABHAKAR, Singapore (SG); Madhukar K. SHANBHAG, Santa Clara, CA (US); Sandeep K. SUNKESALA, San Jose, CA (US); Sanjeevi BALASUBRAMANIAN, San Jose, CA (US); Sharad GARG, Cupertino, CA (US); Shiva Krishna NARRA, San Jose, CA (US); Sree Ram KODALI, San Jose, CA (US); Sriram SUBRAMANIAN, San Jose, CA (US); Vijay GADDE, San Jose, CA (US); Vijay VENKATARAMAN, San Jose, CA (US); Vishwanth Kamala GOVINDARAJU, Mountain View, CA (US); Wei ZHANG, Santa Clara, CA (US)

(21) Appl. No.: 17/249,970

(22) Filed: Mar. 19, 2021

Related U.S. Application Data
(60) Provisional application No. 62/992,009, filed on Mar. 19, 2020.

(51) Int. Cl. H04W 24/10; H04W 24/08

(52) U.S. Cl. CPC H04W 24/10; H04W 24/08

(57) ABSTRACT

A user equipment (UE) may skip certain measurements when it is unlikely that the UE will use the measurements. The UE determines that the UE is configured with one of a measurement gap or gapless measurements, identifies that a predetermined condition has been satisfied and implements a mitigation technique in response to identifying that the predetermined condition has been satisfied, wherein the mitigation technique includes omitting performing one of a measurement during the measurement gap or a gapless measurement, wherein the measurement or the gapless measurement corresponds to a first radio access technology (RAT) that is different than a second RAT on which the UE is currently camped.

### PRIORITY CLAIM/INCORPORATION BY REFERENCE

This application claims priority to U.S. Provisional Application Ser. No. 62/992,009 filed on Mar. 19, 2020 and entitled “Intelligent Measurement Handling,” the entirety of which is incorporated by reference herein.

### BACKGROUND

A user equipment (UE) may establish a connection to at least one of multiple different networks or types of networks. When camped on a cell of a network, the UE may collect measurement data corresponding to the currently camped cell and other cells deployed within the vicinity of the UE's location. The measurement data may influence various aspects of the UE's network connection. For instance, in some scenarios, the measurement data may cause the UE to camp on another cell that corresponds to a radio access technology (RAT) that is different than the RAT of the currently camped cell. In other scenarios, the UE may be configured with multi-RAT dual-connectivity (DC) based on the measurement data. The above examples are just some of the various different types of outcomes that may occur based, at least in part, on the measurement data collected by the UE.

Generally, collecting measurement data is intended to aid the network in providing the UE with a suitable network connection. However, there is a power and performance cost associated with the UE collecting the measurement data. For any of a variety of different reasons, when the UE is camped on a cell of a first RAT, it may be unnecessary for the UE to collect measurement data for a second different RAT. Under conventional circumstances, when it is unnecessary to collect measurement data for a second different RAT, the UE does not adapt its behavior to this type of scenario. As a result, the UE still experiences the power and performance cost of collecting the measurement data corresponding to the second RAT despite it being unnecessary.

### SUMMARY

Some exemplary embodiments are related to a processor of a user equipment (UE) configured to perform operations. The operations include determining that the UE is configured with one of a measurement gap or gapless measurements, identifying that a predetermined condition has been satisfied and implementing a mitigation technique in response to identifying that the predetermined condition has been satisfied, wherein the mitigation technique includes omitting performing one of a measurement during the measurement gap or a gapless measurement, wherein the measurement or the gapless measurement corresponds to a first radio access technology (RAT) that is different than a second RAT on which the UE is currently camped.

Other exemplary embodiments are related to a user equipment (UE) having a transceiver configured to communicate with a first radio access technology (RAT) and a second RAT and a processor configured to perform operations. The operations include determining that the UE is configured with one of a measurement gap or gapless measurements, identifying that a predetermined condition has been satisfied and implementing a mitigation technique in response to identifying that the predetermined condition has been satisfied, wherein the mitigation technique includes omitting performing one of a measurement during the measurement gap or a gapless measurement, wherein the measurement or the gapless measurement corresponds to the first RAT that is different than the second RAT on which the UE is currently camped.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary method for implementing an intelligent measurement handling mitigation technique according to various exemplary embodiments.

FIG. 4 shows an exemplary method for implementing an intelligent measurement handling mitigation technique based on a type of application traffic according to various exemplary embodiments.

FIG. 5 shows an exemplary method for implementing an intelligent measurement handling mitigation technique based on a UE motion state according to various exemplary embodiments.

FIG. 6 shows an exemplary method for implementing an intelligent measurement handling mitigation technique based on measurement data according to various exemplary embodiments.

FIG. 7 shows an exemplary signaling diagram for informing the network about the UE decision to omit a scheduled measurement gap according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing intelligent measurement handling at a user equipment (UE). As will be described in more detail below, a variety of different mitigation techniques may be utilized to mitigate the power and performance cost associated with collecting measurement data. For example, the UE may omit the performance of one or more scheduled measurements corresponding to a radio access technology (RAT) that is different than the currently camped RAT. This allows the UE to mitigate the power and performance cost associated with collecting such measurement data.

The exemplary embodiments are described with regard to a UE. However, the use of a UE is merely for illustrative purposes. The exemplary embodiments may be utilized with any electronic component that may establish a connection with a network and is configured with the hardware, software, and/or firmware to exchange information and data with the network. Therefore, the UE as described herein is used to represent any electronic component.

The exemplary embodiments are also described with regard to a network that includes a 5G new radio (NR) RAT and a Long-Term Evolution (LTE) RAT. In some embodiments, the network may support LTE-NR dual-connectivity (ENDC). Generally, ENDC relates to the UE being configured with multiple component carriers (CCs) where one or more of the CCs correspond to the LTE RAT and one or more CCs correspond to the 5G NR RAT. Each CC may represent a channel that facilitates communication between the UE and the network over a particular frequency band. In general, the more CCs the UE is configured with results in more bandwidth being available for communications with the network. However, reference to 5G NR, LTE and ENDC is only provided for illustrative purposes, different entities may refer to similar concepts by different names.

The exemplary embodiments are further described with regard to measurement gaps. Those skilled in the art will understand that a measurement gap is a predetermined duration of time during which the UE may tune away from its currently camped frequency to listen for signals broadcast by cells over other frequencies. The UE may then generate measurement data based on detected signals.

The network may schedule measurement gaps in any of a variety of different types of measurement gap patterns. For example, one measurement gap pattern may include a 6 millisecond (ms) measurement gap that is scheduled to occur periodically every 40 ms. Thus, every 40 ms the UE may be configured to tune away from its currently camped frequency to collect measurement data during the scheduled 6 ms measurement gap. Another measurement gap pattern may include a 6 ms measurement gap that is scheduled to occur periodically every 80 ms. Thus, every 80 ms the UE may be configured to tune away from its currently camped frequency to collect measurement data during the scheduled 6 ms measurement gap. The above examples are merely provided for illustrative purposes and are not intended to limit the exemplary embodiments to any particular type of measurement gap pattern. The exemplary embodiments may apply to the network scheduling measurement gaps in any appropriate arrangement.

In some configurations, the UE may be capable of performing gapless measurements. Gapless measurements relate to a mechanism that is configured to measure signals broadcast on certain frequencies without tuning away from the currently camped frequency. For example, the UE may be equipped with multiple receivers. A first receiver may remain tuned to the currently camped frequency and a second receiver may be used to measure signals broadcast on other frequency bands. However, this example is merely provided for illustrative purposes. The exemplary embodiments may apply to a UE configured to perform gapless measurements in any appropriate manner.

During operation, the UE may initially be camped on an LTE cell. When camped, the UE may collect measurement data corresponding to the currently camped cell and measurement data corresponding to other cells deployed within the vicinity of the UE's location. As indicated above, the measurement may occur during the network scheduled measurement gaps and/or the UE may be capable of performing gapless measurements. In some scenarios, the measurement data may be used by the network to configure the UE with ENDC. In other scenarios, the measurement data may be used by the UE or the network to transition the UE from the currently camped LTE cell to a 5G NR cell. Regardless of how the measurement data is collected, there is a power and/or performance cost associated with collecting the measurement data. Typically, the power and performance cost is acceptable because it is intended to aid the network in providing the UE with a suitable network connection. However, as will be described below, there may be scenarios in which the UE sacrifices power and performance collecting measurement data corresponding to a particular RAT despite it being unlikely or unnecessary for the UE's network connection to include that particular RAT.

For any of a variety of different reasons, it may be unlikely or unnecessary for the UE to be configured with ENDC or transition from a currently camped LTE cell to a 5G NR cell. To provide an example, a scenario may arise in which the UE is camped on an LTE cell and not within the coverage area of a 5G NR cell. Since the UE is not within 5G NR coverage, the UE in this scenario will not be able to collect any measurement data corresponding to 5G NR cells. However, under conventional circumstances, the UE may still attempt to collect measurement data corresponding to 5G NR cells. When the UE tunes away from the LTE cell during a measurement gap, there is a performance cost because the UE may not exchange data with the LTE cell in either the uplink or the downlink. Further, there is a power cost associated with listening to various frequencies and processing incoming signals in an attempt to collect measurement data corresponding to 5G NR cells. Accordingly, in this conventional scenario, the UE is sacrificing both power and performance attempting to collect measurement data for a 5G NR cell despite the UE being outside of a 5G NR coverage area.

To provide another example, consider a scenario in which the UE is camped on an LTE cell and within the coverage area of one or more 5G NR cells. Further, the UE in this scenario is currently running a messaging application (e.g., short message service (SMS), multimedia message service (MMS), etc.). Typically, the messaging application does not use a high data rate due to the size and frequency of the messages. It is unnecessary for the UE to be configured with ENDC to facilitate this type of application traffic. However, under conventional circumstances, the UE still attempts to collect measurement data corresponding to 5G NR cells during the scheduled measurement gaps. As indicated above, there is both a power and performance cost associated with collecting measurement data for a 5G NR cell. Accordingly, in this conventional scenario, the UE is sacrificing both power and performance attempting to collect measurement data for a 5G NR cell despite it being unnecessary for the UE to be configured with ENDC. The above conventional scenarios are only provided as a general example of types of scenarios in which it may be unlikely or unnecessary for the UE's network connection to include a cell of a particular RAT (e.g., 5G NR).

The exemplary embodiments relate to implementing intelligent measurement handling at the UE. Generally, intelligent measurement handling relates to mitigating the power and performance cost associated with collecting measurement data corresponding to particular RAT when it is unlikely or unnecessary for the UE's network connection to include the particular RAT. To mitigate the power and performance cost, the UE may omit performing measurements the UE is expected to perform under conventional circumstances (e.g., scheduled measurement gaps, gapless measurements). Specific examples of mitigating the power and performance cost associated with collecting measurement data will be described in more detail below. The exemplary techniques described herein may be used in conjunction with other currently implemented measurement techniques, future implementations of measurement techniques or independently from other measurement techniques.

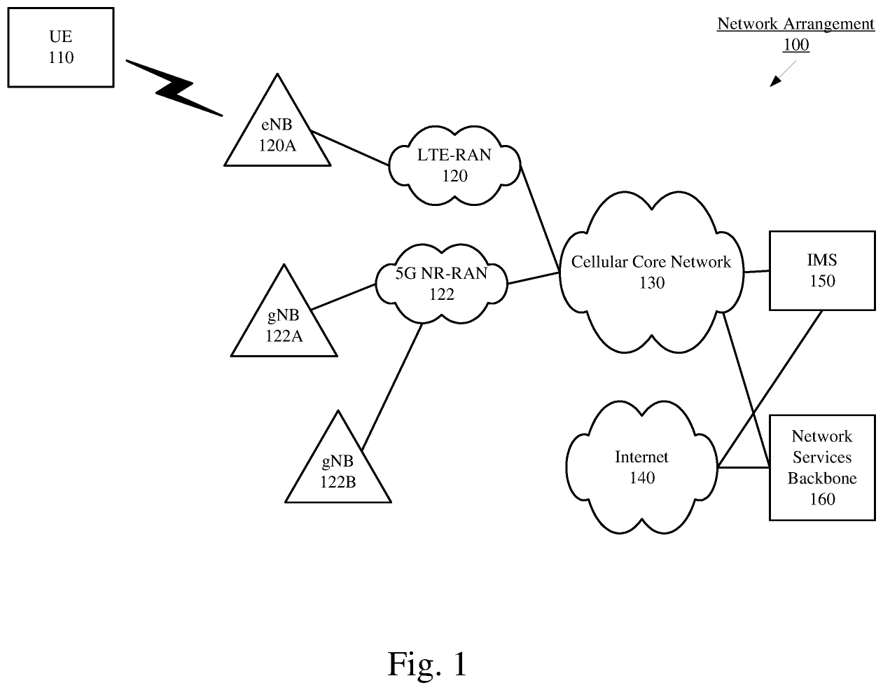

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are an LTE radio access network (LTE-RAN) 120 and a 5G New Radio (NR) radio access network (5G NR-RAN) 122. However, it should be understood that the UE 110 may also communicate with other types of networks (e.g. legacy cellular network, WLAN, etc.) and the UE 110 may also communicate with networks over a wired connection. With regard to the exemplary embodiments, the UE 110 may establish a connection with the 5G NR-RAN 122 and/or the LTE-RAN 120. Therefore, the UE 110 may have both an LTE chipset to communicate with the LTE-RAN 120 and a 5G NR chipset to communication with the 5G NR-RAN 122.

The LTE-RAN 120 and the 5G NR-RAN 122 may be portions of cellular networks that may be deployed by cellular providers (e.g., Verizon, AT&T, T-Mobile, etc.). These networks 120 and 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The use of a separate LTE-RAN 120 and a 5G NR-RAN 122 is merely provided for illustrative purposes. An actual network arrangement may include a radio access network that includes an architecture that is capable of providing both 5G NR RAT and LTE RAT services. For example, a next-generations radio access network (NG-RAN) (not pictured) may include a next generation Node B (gNB) that provides 5G NR services and a next generation evolved Node B (ng-eNB) that provides LTE services. The NG-RAN may be connected to at least one of the evolved packet core (EPC) or the 5G core (5GC). Thus, in one exemplary configuration, the UE 110 may achieve ENDC by establishing a connection to at least one cell corresponding to the LTE-RAN 120 and at least one cell corresponding to the 5G NR-RAN 122. In another exemplary configuration, the UE 110 may achieve ENDC by establishing a connection to at least two cells corresponding to the NG-RAN or other type of similar RAN. Accordingly, the example of a separate LTE-RAN 120 and a 5G NR-RAN 122 is merely provided for illustrative purposes.

Returning to the exemplary network arrangement 100, the UE 110 may connect to the LTE-RAN 120 via the evolved Node B (eNB) 120A. The UE 110 may connect to the 5G NR-RAN 122 via at least one of the next generation Node B (gNB) 122A or gNB 122B. Those skilled in the art will understand that any association procedure may be performed for the UE 110 to connect to the LTE-RAN 120 or the 5G NR-RAN 122. For example, as discussed above, the 5G NR-RAN 122 may be associated with a particular cellular provider where the UE 110 and/or the user thereof has a contract and credential information (e.g., stored on a SIM card). Upon detecting the presence of the 5G NR-RAN 122, the UE 110 may transmit the corresponding credential information to associate with the 5G NR-RAN 122. More specifically, the UE 110 may associate with a specific cell (e.g., the gNB 122A of the 5g NR-RAN 122). Similarly, for access to LTE services, the UE 110 may associate with eNB 120A. However, as mentioned above, the use of the LTE-RAN 120 and the 5G NR-RAN 122 is for illustrative purposes and any appropriate type of RAN may be used.

In addition to the RANs 120 and 122, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the EPC and/or the 5GC. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

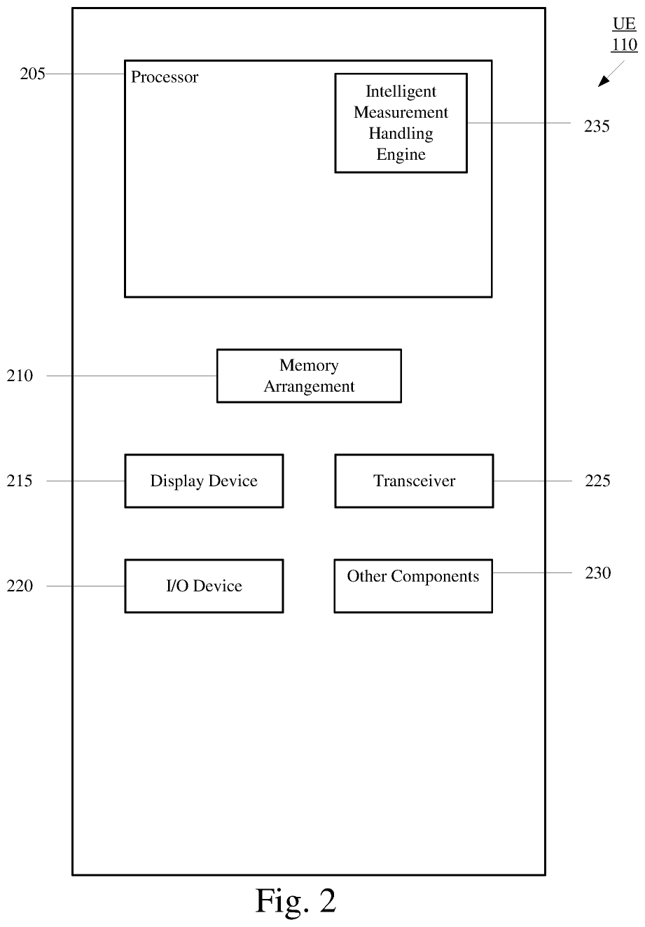

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an intelligent measurement handing engine 235. The intelligent measurement handling engine 235 may implement any of a variety of different mitigation techniques configured to mitigate the power and/or performance cost associated with collecting measurement data corresponding to a particular RAT.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the LTE-RAN 120, the 5G NR-RAN 122 etc. Accordingly, the transceiver 225 may operate on a variety of different frequencies or channels (e.g., set of consecutive frequencies).

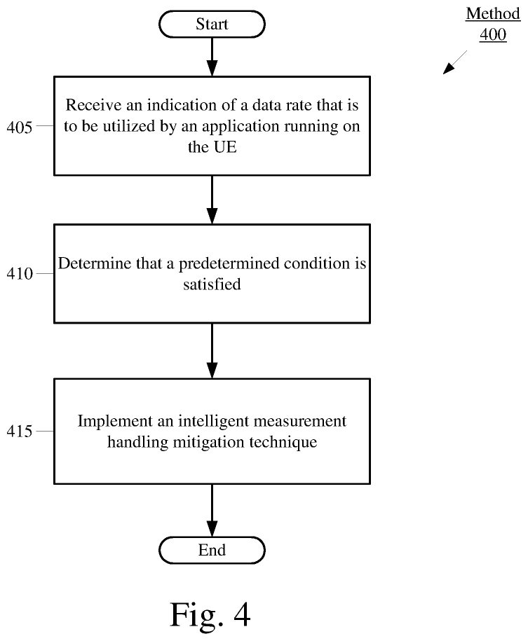

The method 300 relates to a dynamic measurement gap during which the UE 110 may decide to omit performing a measurement. This is in contrast to conventional procedures where the UE 110 is not configured with this type of decision-making ability. Accordingly, the exemplary embodiments relate to providing the UE 110 with the capability of determining how to utilize a scheduled measurement gap. As indicated above, in some exemplary embodiments, the UE 110 may omit attempting to collect measurement data when it is unlikely that signals originating from a cell of a particular RAT are available to be measured. In other exemplary embodiments, the UE 110 may omit collecting measurement data when it is unnecessary for the UE 110 network connection to include a particular RAT. The method 300 will provide a general overview of how the UE 110 may determine when to implement any of a variety of different intelligent measurement handling mitigation techniques. FIGS. 4-6 will provide specific examples of intelligent measurement handling mitigation techniques.

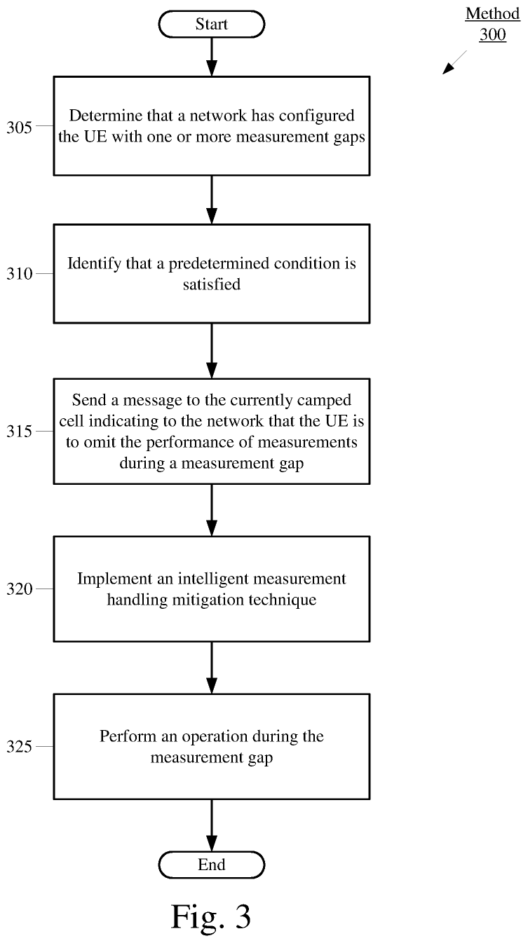

FIG. 3 shows an exemplary method 300 for implementing an intelligent measurement handling mitigation technique according to various exemplary embodiments. The method 300 will be described with regard to the UE 110 of FIG. 2 and the network arrangement 100 of FIG. 1.

In 305, the UE 110 determines that the network has configured the UE 110 with one or more measurement gaps. For example, the UE 110 may be camped on the eNB 120A of the LTE-RAN 120. During radio resource control (RRC) signaling with the eNB 120A, the network may configure the UE 110 with multiple measurement gaps that may be used to measure signals broadcast by 5G NR cells. As indicated above, there are various different types of measurement gap patterns. The exemplary embodiments are not limited to any particular measurement gap pattern and may apply to any scenario in which the network configures the UE 110 with one or more measurement gaps.

In 310, the UE 110 identifies that a predetermined condition is satisfied. The predetermined condition may indicate to the UE 110 that it is unlikely or unnecessary for the UE 110 network connection to include a 5G NR RAT. In other words, it is unlikely or unnecessary for the UE 110 to be configured with ENDC or to transition from being camped on the eNB 120A to a 5G NR cell. Accordingly, in response to the first predetermined condition being satisfied, the UE 110 may implement an intelligent measurement handling mitigation technique. Generally, the intelligent measurement handling mitigation technique may include omitting the performance of a measurement during a scheduled measurement gap.

As will be described in more detail below with regard to FIG. 4, the predetermined condition may correspond to the type of traffic associated with an application running on the UE 110. If the application traffic satisfies the predetermined condition, the UE 110 may implement an intelligent measurement handling mitigation technique because it is unnecessary for the UE 110 network connection to include the 5G NR RAT.

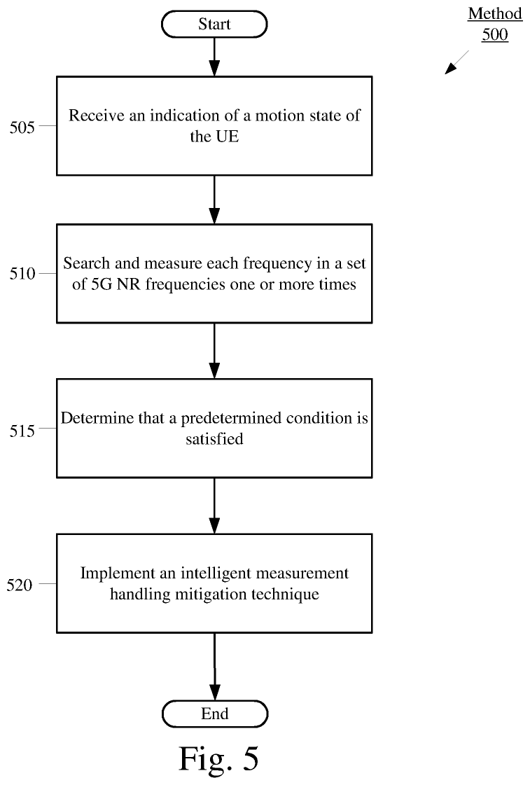

As will be described in more detail below with regard to FIG. 5, the predetermined condition may correspond to a motion state of the UE 110. If the UE 110 is stationary (or semi-stationary) and measurement data has already been collected, the UE 110 may implement an intelligent measurement handling mitigation technique because it is unlikely that the measurement data will change between a first scheduled measurement gap and a second scheduled measurement gap.

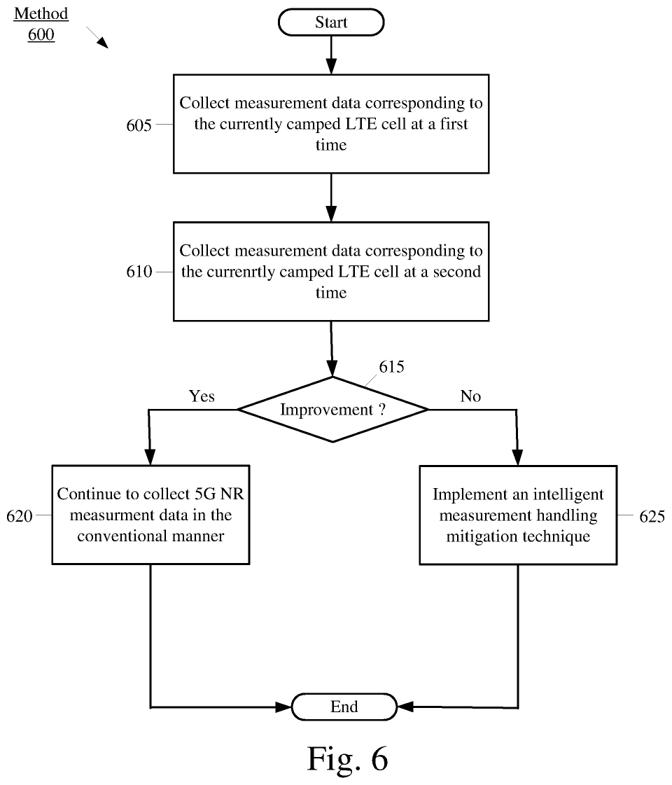

As will be described in more detail below with regard to FIG. 6, the predetermined condition may correspond to LTE measurement data. If the LTE measurement data degrades, the UE 110 may implement an intelligent measurement handling mitigation technique because it is unlikely that the network will configure the UE 110 with ENDC under these types of conditions.

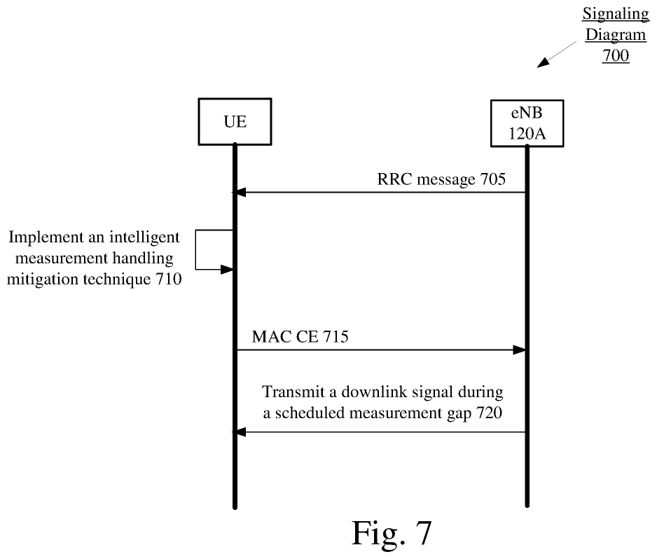

Returning to the method 300, in 315, the UE 110 sends a message to the currently camped cell indicating to the network that the UE 110 is going to omit performing measurements during a scheduled measurement gap. Under conventional circumstances, the network may not transmit data and/or information to the UE 110 during a scheduled measurement gap because the network expects the UE 110 to be listening to a different frequency band. As will be described in more detail below with regard to FIG. 7, the message in 315 allows the network to understand that the UE 110 will not be tuned away from the currently camped frequency and thus, the network may transmit data and/or information to the UE 110 during the scheduled measurement gap.

In 320, the UE 110 implements an intelligent measurement handling mitigation technique. As indicated above, the mitigation technique may be implemented in response to the predetermined condition being satisfied and may include omitting the performance of a measurement corresponding to a particular RAT (e.g., 5G NR) during a scheduled measurement gap.

In 325, the UE 110 performs an operation during the scheduled measurement gap. As indicated above, in some embodiments, the operation may be receiving data and/or information from the currently camped cell during the measurement gap because the network is aware that the UE 110 is not tuned away during the scheduled measurement gap. As will be explained below, the UE 110 may also perform other types of operations during the scheduled measurement gap.

Under conventional circumstances, measurement gaps are prioritized over other operations. For example, if there is a conflict in time between the transmission of a scheduling request and a measurement gap, the transmission of the scheduling request may be delayed. In another example, if there is a conflict in time between a configured grant (e.g., UL grant) and a measurement gap, the configured grant may be ignored by the UE 110. Similarly, if there is a conflict between hybrid automatic repeat request (HARQ) feedback and a measurement gap, the UE 110 may not transmit the HARQ feedback. The above examples are merely provided for illustrative purposes and are intended to demonstrate that under conventional circumstances, the UE 110 may prioritize collecting measurement data during a scheduled measurement gap over other operations.

The exemplary embodiments may include the UE 110 performing an uplink transmission (e.g., scheduling request, configured grant, HARQ feedback) during a scheduled measurement gap when the UE 110 selects to omit performing the measurements during the scheduled measurement gap. Thus, in 325, the UE 110 may receive a downlink signal or perform an uplink transmission during a time duration that was initially scheduled as a measurement gap. Subsequently, the method 300 ends.

FIG. 4 shows an exemplary method 400 for implementing an intelligent measurement handling mitigation technique based on a type of application traffic according to various exemplary embodiments. The method 400 will be described with regard to the method 300 of FIG. 3, the UE 110 of FIG. 2 and the network arrangement 100 of FIG. 1.

As described above with regard to the method 300, the UE 110 may omit performing a measurement during a measurement gap in response to identifying that a predetermined condition is satisfied. The method 400 relates to a predetermined condition that is based on a type of application traffic. Initially, consider the following exemplary scenario, the UE 110 is currently camped on the eNB 120A of the LTE-RAN 120 and is located within the coverage area of the gNB 122A and the gNB 122B of the 5G NR-RAN 122.

In 405, the UE 110 receives an indication of the data rate that is to be utilized by an application running on the UE 110. The exemplary embodiments are not limited to any particular type of application and may apply to any type of application running in either the foreground or the background.

From the perspective of the UE 110, the indication may be sent by the application processor of the UE 110 to the baseband processor of the UE 110. In this example, the application processor may indicate either a high data rate or a low data rate. However, characterizing the application traffic in this manner is only provided for illustrative purposes and is not intended to limit the exemplary embodiments in any way. This exemplary embodiment relates to the application processor causing the baseband processor to either perform a scheduled measurement or omit a scheduled measurement and the application processor may trigger this type of behavior based on any appropriate basis. For example, the application processor may set a threshold and if the proposed data rate for the executing application is above the threshold, this may be considered to be a high data rate and if the proposed data rate for the executing application is below the threshold, this may be considered to be a low data rate.

If the application processor determines that the application running on the UE 110 is to utilize a high data rate, the application processor may provide an indication to the baseband processor that causes the baseband processor to perform measurements in the conventional manner. For example, if the application running on the UE 110 is for streaming video, the application processor may want a network connection that is capable of providing the highest available data rate. Thus, the UE 110 may continuously search for 5G NR cells (e.g., the gNB 122A and the gNB 122B) by using scheduled measurement gaps and/or gapless measurements in the conventional manner. This ensures that the UE 110 is attempting to configure a network connection that includes a cell belonging to the 5G NR RAT (e.g., ENDC, transitioning from the eNB 120A to the gNB 122A or the gNB 122B).

If the application running on the UE 110 is for a messaging application (e.g., SMS, MMS, etc.) or push notifications, it may be unnecessary for the UE 110 to be configured with the highest available data rate. Instead, a low data rate may be used to exchange messages and receive push notifications from the network. Thus, the UE 110 may choose to mitigate the power and performance cost associated with performing measurements in the conventional manner because it is unnecessary for the UE 110 to be configured with the 5G NR RAT. In this example, the indication in 405 indicates that the application running on the UE 110 is not a high data rate application.

The above example described the application processor sending an explicit indication of a high data rate or a low data rate to the baseband processor. In other embodiments, the application processor may send a set of information related to the type of application traffic that is to be utilized by the application running on the UE 110 and the baseband processor may determine the type of data rate based on the set of information provided by the application processor.

In 410, the UE 110 determines that a predetermined condition is satisfied based on the indication received in 405. For example, as indicated above, the predetermined condition in 310 may be based on the type of application traffic that is to be utilized by an application running on the UE 110.

In 415, the UE 110 implements an intelligent measurement handling mitigation technique. As indicated above, in some embodiments, the mitigation technique may include omitting the performance of measurements during a measurement gap. In other embodiments, the mitigation technique may include omitting the performance of gapless measurements during instances in which gapless measurements are configured to be performed. Thus, despite being within the coverage area of the gNB 122A and the gNB 122B, the UE 110 may mitigate the power and performance costs associated with collecting measurement data corresponding to the 5G NR RAT because, in this example, it is unnecessary for the UE 110 to be configured with ENDC or camp on a 5G NR cell. Subsequently, the method 400 ends.

FIG. 5 shows an exemplary method 500 for implementing an intelligent measurement handling mitigation technique based on a UE 110 motion state according to various exemplary embodiments. The method 500 will be described with regard to the method 300 of FIG. 3, the UE 110 of FIG. 2 and the network arrangement 100 of FIG. 1.

As described above with regard to the method 300, the UE 110 may omit performing a measurement during a measurement gap in response to identifying that a predetermined condition is satisfied. The method 500 relates to a predetermined condition that is based on a motion state of the UE 110. Initially, consider the following exemplary scenario, the UE 110 is currently camped on the eNB 120A of the LTE-RAN 120 and is located within the coverage area of the gNB 122A and the gNB 122B of the 5G NR-RAN 122.

In 505, the UE 110 receives an indication of the motion state of the UE 110. From the perspective of the UE 110, the motion state may be estimated by an always on processor (AOP). The AOP may provide the information to the baseband processor and/or the intelligent measurement handling engine 235. However, reference to the AOP is merely provided for illustrative purposes, any appropriate mechanism may be used to determine the motion state of the UE 110.

In this example, the AOP may indicate either a stationary motion state, a semi-stationary motion state or a mobile state. If the AOP information is not available, the UE 110 may consider the motion state to be stationary. However, reference to a stationary motion state, a semi-stationary motion state and a mobile state is merely provided for illustrative purposes, different entities may refer to similar concepts by a different name.

If the UE 110 is in a mobile state, the UE 110 may want to perform measurements in the conventional manner. For example, the UE 110 may be moving between coverage areas of various cells (e.g., eNB 120A, gNB 122A, gNB 122B) and thus, the cellular conditions relevant to the UE 110 may not be static. Accordingly, the UE 110 may want to perform measurements in the conventional manner (e.g., measurement gaps or gapless measurements) to ensure that the UE 110 is configured with a suitable network connection as it moves between coverage areas.

If the UE 110 is in the stationary state or the semi-stationary state, the UE 110 may want to mitigate the power and performance costs of collecting measurement data in the conventional manner after the UE 110 has searched and measured 5G NR frequencies at the current stationary or semi-stationary location of the UE 110. For example, at a first time and at a first location, the UE 110 may search and measure frequencies associated with a 5G NR RAT one or more times in the conventional manner. If the UE 110 is in the stationary or semi-stationary state, the UE 110 may assume that the measurement data collected at the first time will remain relatively static when the next conventional measurement opportunity arises. Thus, it may be unnecessary for the UE 110 to collect measurement data during the next measurement gap or instance in which a gapless measurement is to be performed. In this example, it may be considered that the UE 110 is in the stationary state or the semi-stationary state.

In 510, the UE 110 searches and measures each frequency in a set of 5G NR frequencies one or more times. If measurement data corresponding to a cell operating on one of the 5G NR frequencies triggers a measurement report, the UE 110 may send the measurement report in accordance with conventional procedures. However, in this example, a measurement report is not triggered.

In 515, the UE 110 determines that a predetermined condition is satisfied. In this example, the predetermined condition may be based on identifying that the set of 5G NR RAT frequencies have been searched and measured by the UE 110 while the UE 110 is in the stationary or semi-stationary motion state. This predetermined condition may be the same predetermined condition mentioned above with regard to the method 300.

In 520, the UE 110 implements an intelligent measurement handling mitigation technique. As indicated above, in some embodiments, the mitigation technique may include omitting the performance of measurements during a measurement gap. In other embodiments, the mitigation technique may include omitting the performance of gapless measurements during instances in which gapless measurements are configured to be performed. In further embodiments, the mitigation technique may include reducing the measurement periodicity from a first duration to a second duration. For example, instead of utilizing every scheduled measurement gap (e.g., every (x) ms), the UE 110 may instead utilize a measurement gap every (n) ms where (n) is greater than (x). Subsequently, the method 500 ends.

FIG. 6 shows an exemplary method 600 for implementing an intelligent measurement handling mitigation technique based on measurement data according to various exemplary embodiments. The method 600 will be described with regard to the method 300 of FIG. 3, the UE 110 of FIG. 2 and the network arrangement 100 of FIG. 1.

As described above with regard to the method 300, the UE 110 may omit performing a measurement during a measurement gap in response to identifying that a predetermined condition is satisfied. The method 600 relates to a predetermined condition that is based on LTE RAT measurement data. Initially, consider the following exemplary scenario, the UE 110 is currently camped on the eNB 120A of the LTE-RAN 120 and is located within the coverage area of the gNB 122A and the gNB 122B of the 5G NR-RAN 122. In this scenario, the LTE frequency of the currently camped cell may be the lower band compared to the available 5G NR frequencies.

In 605, the UE 110 collects measurement data corresponding to the currently camped LTE cell (e.g., eNB 120A) at a first time. In this example, the measurement data for the LTE cell is reference signal received power (RSRP). However, reference to RSRP is only provided for illustrative purposes. Those skilled in the art will understand that the term measurement data may encompass a wide array of different parameters. The exemplary embodiments may apply to any appropriate type of measurement data.

In 610, the UE 110 collects measurement data corresponding to the currently camped LTE cell (e.g., eNB 120A) at a second time.

In 615, the UE 110 determines whether the measurement data corresponding to the first time and the measurement data corresponding to the second time indicate an improvement in cellular conditions. For example, if the RSRP at the second time is higher than the RSRP at the first time this may indicate to the UE 110 that the cellular conditions are improving. If the RSRP at the second time is lower than the RSRP at the first time, this may indicate to the UE 110 that the cellular conditions are degrading. If the there is an improvement, the method 600 continues to 620.

In 620, the UE 110 continues to collect measurement data corresponding to 5G NR RAT in the conventional manner. When there is an improvement in the LTE RSRP, this may indicate that the UE 110 is moving closer to the currently camped cell and there is a greater possibility of the network configuring the UE 110 with ENDC. Thus, since it is likely that the UE 110 network connection may include the 5G NR RAT (e.g., ENDC), the UE 110 may sacrifice power and performance to achieve this configuration.

Returning to 615, if there is not an improvement, the method 600 continues to 625. In 625, the UE 110 may implement an intelligent measurement handling mitigation technique. When there is a degradation in the LTE RSRP, this may indicate there is a low likelihood of the network configuring the UE 110 with ENDC. Thus, since it is unlikely that the UE 110 network connection may include the 5G NR RAT (e.g., ENDC), the UE 110 may mitigate the power and performance costs of collecting 5G NR measurement data in the conventional manner. As indicated above, in some embodiments, the mitigation technique may include omitting the performance of measurements during a measurement gap. In other embodiments, the mitigation technique may include omitting the performance of gapless measurements during instances in which gapless measurements are configured to be performed. In further embodiments, the mitigation technique may include reducing the measurement periodicity from a first duration to a second duration. For example, instead of utilizing every scheduled measurement gap (e.g., every (x) ms), the UE 110 may instead utilize a measurement gap every (n) ms where (n) is greater than (x). Subsequently, the method 600 ends.

FIG. 7 shows an exemplary signaling diagram 700 for informing the network about the UE 110 decision to omit a scheduled measurement gap according to various exemplary embodiments. The signaling diagram 700 will be described with regard to the method 300 of FIG. 3, the UE 110 of FIG. 2 and the network arrangement 100 of FIG. 1.

As indicated above in 315 of the method 300, the UE 110 may send a message to the UE 110 indicating that the UE 110 is going to omit a scheduled measurement gap. Under conventional circumstances, the network does not transmit information and/or data to the UE 110 during a measurement gap because the network expects the UE 110 to be tuned away from the currently camped frequency during the measurement gap. This message indicates to the network that the UE 110 will be not be tuned away during the scheduled measurement gap and thus, the UE 110 is available to receive information and/or data in the downlink during a scheduled measurement gap. The signaling diagram 700 shows a signaling exchange that may occur between the UE 110 and the currently camped eNB 120A during this type of scenario.

In 705, the eNB 120A transmits an RRC message to the UE 110. The RRC message may include a dynamic gap offset indication. This indication may indicate to the UE 110 that scheduled measurement gaps may be treated as dynamic measurement gaps.

In 710, the UE 110 implements an intelligent measurement handling mitigation technique. As indicated above, this may include not collecting measurement data during a scheduled measurement gap. For example, the UE 110 may determine that a measurement gap that is scheduled to start at time (T) is not be utilized by the UE 110 in the conventional manner.

In 715, the UE 110 sends an indication to the eNB 120A indicating that the UE 110 will not tune away during an upcoming measurement gap. This indication may be sent to the eNB 120A in a medium access control (MAC) control element (CE). For example, the MAC CE may indicate that the measurement gap that is supposed to start at time (T) is not to be utilized by the UE 110.

In 720, the eNB 120A sends a downlink signal to the UE 110 during the scheduled measurement gap. Since the eNB 120A is informed about the UE 110 decision to not utilize the measurement gap, the eNB 120A know that the UE 110 will not tune away and is available to received downlink signals.

The signaling diagram 700 was merely provided for illustrative purposes and the exemplary embodiments are not limited to this type of signaling exchange. The UE 110 may omit performing operations associated with collecting measurement data during a measurement gap regardless of whether an indication is received from the network. Further, the UE 110 is not required to inform the network about its decision to omit performing operations associated with collecting measurement data during a measurement gap.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
determining that the UE is configured with one of a measurement gap or gapless measurements;
identifying that a predetermined condition has been satisfied; and
implementing a mitigation technique in response to identifying that the predetermined condition has been satisfied, wherein the mitigation technique includes omitting performing one of a measurement during the measurement gap or a gapless measurement, wherein the measurement or the gapless measurement corresponds to a first radio access technology (RAT) that is different than a second RAT on which the UE is currently camped.

2. The processor of claim 1, wherein the first RAT is a 5G New Radio (NR) RAT and the second RAT is a Long-Term Evolution (LTE) RAT.

3. The processor of claim 1, wherein the predetermined condition is based an application processor of the UE providing an indication of a data rate that is to be utilized by an application running on the UE.

4. The processor of claim 1, wherein the operations further comprise:
searching and measuring a set of frequencies corresponding to the first RAT.

5. The processor of claim 4, wherein the predetermined condition is based on i) a motion state of the UE and ii) performing the searching and measuring of the set of frequencies corresponding to the first RAT a predetermined number of times.

6. The processor of claim 5, wherein the motion state is determined by an always on processor.

7. The processor of claim 5, wherein the motion state is one of stationary or semi-stationary.

8. The processor of claim 1, wherein the predetermined condition is based on a difference between a first reference signal received power (RSRP) corresponding to a currently camped cell and a second RSRP corresponding to the currently camped cell.

9. The processor of claim 1, wherein the operations further comprise:
sending an indication to the second RAT indicating that the UE is to omit performing the measurement during the measurement gap.

10. The processor of claim 9, wherein the indication is included in a medium access control (MAC) control element (CE).

11. The processor of claim 9, wherein the operations further comprise:
receiving a downlink signal from the network during the measurement gap.

12. The processor of claim 1, wherein the operations further comprise:
performing an uplink transmission during the measurement gap.

13. The processor of claim 12, wherein the uplink transmission is associated with one of a scheduling request, a configured grant or a hybrid automatic repeat request (HARQ) feedback.

14. A user equipment (UE), comprising:
a transceiver configured to communicate with a first radio access technology (RAT) and a second RAT; and
a processor configured to perform operations comprising:
determining that the UE is configured with one of a measurement gap or gapless measurements;
identifying that a predetermined condition has been satisfied; and
implementing a mitigation technique in response to identifying that the predetermined condition has been satisfied, wherein the mitigation technique includes omitting performing one of a measurement during the measurement gap or a gapless measurement, wherein the measurement or the gapless measurement corresponds to the first RAT that is different than the second RAT on which the UE is currently camped.

15. The UE of claim 14, wherein the first RAT is a 5G new radio (NR) RAT and the second RAT is a long-term evolution (LTE) RAT.

16. The UE of claim 14, further comprising:
an application processor, wherein the predetermined condition is based on whether the application processor has provided an indication of a data rate that is to be utilized by an application running on the UE.

17. The UE of claim 14, wherein the operations further comprise:
searching and measuring a set of frequencies corresponding to the first RAT.

18. The UE of claim 17, wherein the predetermined condition is based on i) a motion state of the UE and ii) performing the searching and measuring of the set of frequencies corresponding to the first RAT a predetermined number of times.

19. The UE of claim 19, wherein the motion state is one of stationary or semi-stationary.

20. The UE of claim 14, wherein the predetermined condition is based on a difference between a first reference signal received power (RSRP) corresponding to a currently camped cell and a second RSRP corresponding to the currently camped cell.
